(19) United States
(12) Patent Application Publication
(10) Pub. No.: US 2022/0242078 A1
(43) Pub. Date: Aug. 4, 2022

(54) MOTOR-DRIVEN POWDER MOLDING MACHINE

(71) Applicant: TOYOTA JIDOSHA KABUSHIKI KAISHA, Toyota-shi (JP)

(72) Inventor: Makoto WATANABE, Toyota-shi (JP)

(73) Assignee: TOYOTA JIDOSHA KABUSHIKI KAISHA, Toyota-shi (JP)

(21) Appl. No.: 17/646,182

(22) Filed: Dec. 28, 2021

(30) Foreign Application Priority Data
Feb. 2, 2021 (JP) 2021-014759

(51) Int. Cl. B30B 11/00; B30B 15/28; B22F 3/03; B30B 15/14; B30B 11/10

(52) U.S. Cl. CPC B30B 11/005; B30B 15/281; B30B 11/10; B30B 15/148; B22F 2203/13; B22F 3/03

(57) ABSTRACT

A motor-driven powder molding machine according to the present disclosure molds powder using an upper mold and a lower mold and includes, in each of the upper and lower molds, a main ram for operating the upper or lower mold through a main shaft; an auxiliary ram for operating the upper or lower mold through an auxiliary shaft in synchronization with the main ram; and a pressure detector for detecting a pressure in an axial direction in at least one of the main ram and the auxiliary ram. The motor-driven powder molding machine further includes a controller for controlling operation speeds of the upper and lower molds by at least one of the main ram and the auxiliary ram so that the pressure falls within a predetermined range based on the detected pressure.

### CROSS REFERENCE TO RELATED APPLICATIONS

This application is based upon and claims the benefit of priority from Japanese patent application No. 2021-014759, filed on Feb. 2, 2021, the disclosure of which is incorporated herein in its entirety by reference.

### BACKGROUND

The present disclosure relates to a motor-driven powder molding machine.

In recent years, there has been a demand for motorizing a powder molding machine for manufacturing machine parts by filling powder into a mold and then compressing the powder, in terms of the reduction of CO₂ emissions and environmental protection. Under such circumstances, an electric powder molding machine, which is composed using an electric apparatus, has been developed instead of a hydraulic drive powder molding machine of related art. The electric powder molding machine can greatly shorten the time for equipment adjustment.

The electric powder molding machine can only mold a sintered part with a simple structure, if the electric powder molding machine has a structure having an upper mold with one shaft and a lower mold with one shaft. It is thus demanded to develop an electric powder molding machine capable of forming more complicated sintered parts by providing upper and lower stages. Japanese Unexamined Patent Application Publication No. 2017-205769 discloses a technique of an electric powder molding machine which acquires a moving speed of an upper mold, multiplying the moving speed by a predetermined speed rate, and setting a target speed of a lower mold to follow the lower mold.

### SUMMARY

Even in the case of following the lower mold according to the moving speed of the upper mold, if either the lower mold or the upper mold reaches a limit position of a movable range, a load increase due to a control delay against a rapid increase in a pressurizing speed occurs, and components of the mold or equipment may be damaged.

An object of the present disclosure is to provide a motor-driven powder molding machine for solving such a problem.

A motor-driven powder molding machine according to the present disclosure molds powder using an upper mold and a lower mold, the motor-driven powder molding machine including: in the upper and lower molds, a main ram configured to operate the upper or lower mold through a main shaft; an auxiliary ram configured to operate the upper or lower mold through an auxiliary shaft in synchronization with the main ram; a pressure detector for detecting a pressure in an axial direction in at least one of the main ram and the auxiliary ram; and a controller for controlling operation speeds of the upper and lower molds by at least one of the main ram and the auxiliary ram so that the pressure falls within a predetermined range based on the detected pressure.

According to the present disclosure, it is possible to provide a motor-driven powder molding machine capable of reducing a control delay against a rapid increase in a pressurizing speed.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a cross-sectional view showing a configuration of a motor-driven powder molding machine according to a first embodiment of the present disclosure;

FIG. 2 is a cross-sectional view showing a configuration of an auxiliary ram servo unit according to the first embodiment of the present disclosure;

FIG. 3 is a cross-sectional view showing a configuration of a motor-driven powder molding machine according to a second embodiment of the present disclosure; and

FIG. 4 shows a procedure for powder molding using a motor-driven powder molding machine according to related art.

### DESCRIPTION OF EMBODIMENTS

Hereinafter, embodiments will be described with reference to the drawings. Since the drawings are simplified, the technical scope of the embodiments should not be narrowly interpreted on the basis of the description of the drawings. The same elements are denoted by the same reference signs, and repeated descriptions are omitted. When reference is made to the number of elements or the like including the number of pieces, numerical values, quantity, range, etc. in the following embodiments, the number thereof is not limited to a specific number and may be greater than or less than or equal to the specific number unless otherwise particularly specified and definitely limited to the specific number in principle.

### <History of Study Until Motor-Driven Powder Molding Machine According to the Embodiments is Conceived>

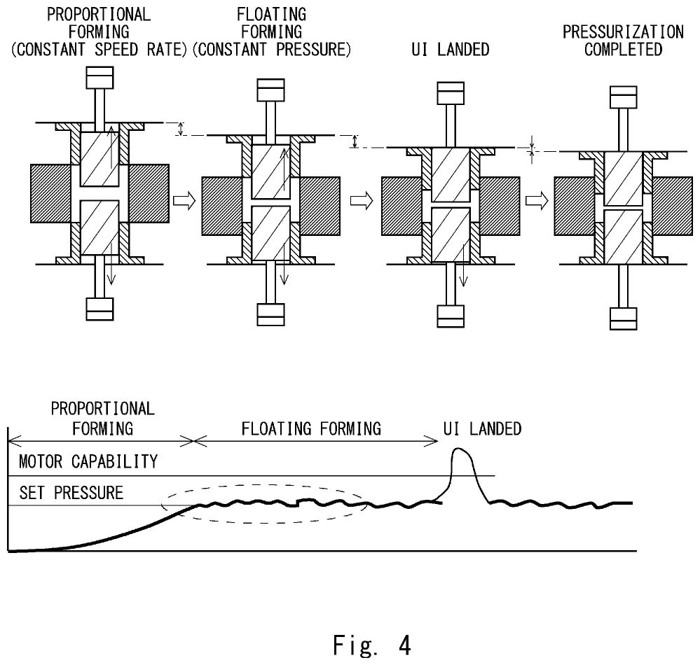

First, a motor-driven powder molding machine according to related art will be described with reference to FIG. 4. FIG. 4 shows a procedure of powder molding in a cavity formed using an upper mold and a lower mold using a motor-driven powder molding machine in a conceptual stage before the embodiments are conceived.

As a premise, in the case of equipment with a configuration in which two ball screws are diagonally arranged for driving one shaft, the number of servo units to be used is greatly increased, and simplification of the equipment becomes a problem. In order to simplify the equipment, it is necessary to use single motor and ball screw drive for single shaft drive. However, there is a concern that the equipment may be damaged for the following reasons.

Specifically, a multi-stage forming is assumed in which the mold is divided by the number of stages of a product and a compression rate of each part under pressure is maintained within an appropriate range. In the case of multi-stage forming, if floating axes for performing Proportional Integral Differential (PID) speed control while monitoring a control pressure during pressurization are arranged to face each other, when either the lower mold or the upper mold reaches a limit position of a movable range, a control delay for a rapid increase in pressurizing speed can occur. The increased pressure associated with the control delay can damage the mold or the components of the equipment.

The graph of FIG. 4 schematically shows a pressure applied to a shaft during forming using an upper mold and a lower mold. As shown in FIG. 4, an upper shaft moves upward and a lower shaft moves downward by the pressure applied from a product during forming. Even when a pressure is monitored using a load cell, a rapid increase in the pressure can occur when either the lower mold or upper mold reaches a limit position of a movable range. Furthermore, if the pressure applied to the load cell is increased rapidly, the control may not be able to keep up. In such a case, the motor-driven powder molding machine and peripheral equipment may be damaged.

Therefore, a motor-driven powder molding machine according to the following embodiments which can solve such a problem has been found.

### First Embodiment

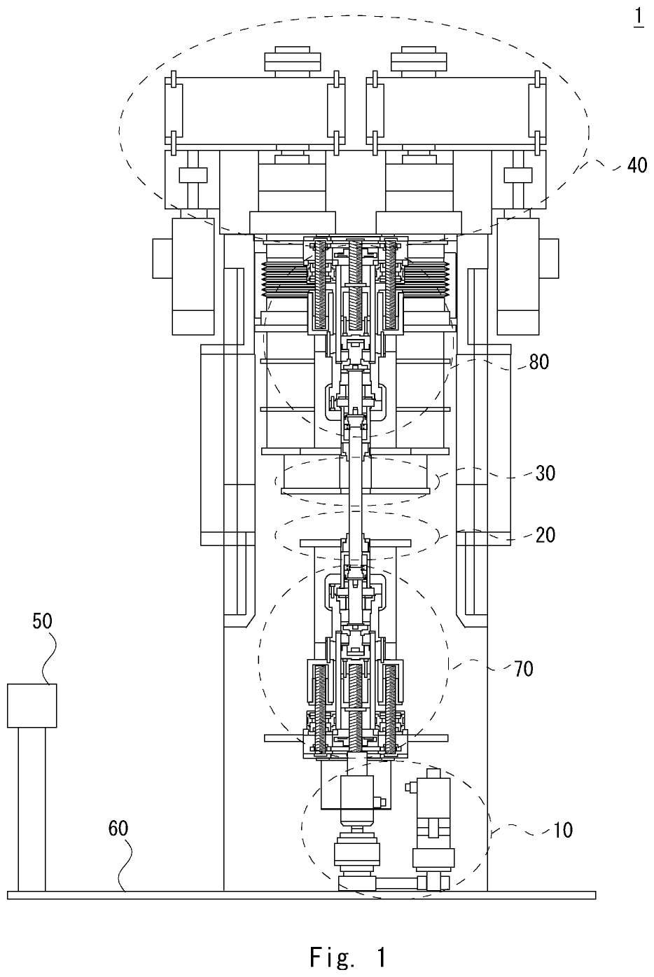

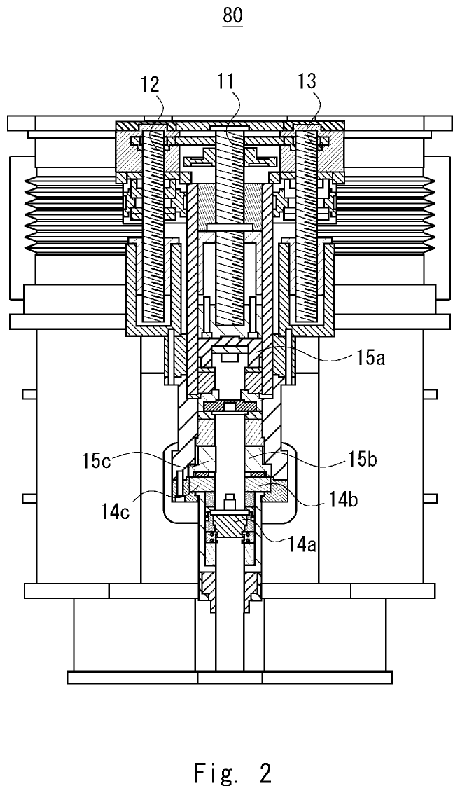

A motor-driven powder molding machine 1 according to this embodiment will be described with reference to FIGS. 1 and 2. FIG. 1 is a cross-sectional view showing a configuration of a motor-driven powder molding machine 1 according to this embodiment. FIG. 2 is a cross-sectional view showing a configuration of an auxiliary ram servo unit of the motor-driven powder molding machine 1 according to this embodiment. FIG. 2 is an upper mold auxiliary ram servo unit 80 to be described later and has the same configuration as that of a lower mold auxiliary ram servo unit 70. Thus, a description of the configuration of the lower mold auxiliary ram servo unit 70 will be omitted.

As shown in FIG. 1, the motor-driven powder molding machine 1 is disposed, for example, on a base 60. The motor-driven powder molding machine 1 has a rectangular parallelepiped shape extending in a direction perpendicular to the base 60. The motor-driven powder molding machine 1 includes an lower mold main ram servo unit 10, a lower mold 20, an upper mold 30, an upper mold main ram servo unit 40, and a control unit 50.

In a motor-driven powder molding machine 1, a powder material is filled in a cavity formed using the upper mold 30 and the lower mold 20. A pressure is applied to the filled powder material by the upper mold main ram servo unit 40 and the lower mold main ram servo unit 10, so that the powder material is subjected compression forming. The upper mold main ram servo unit 40 operates the upper mold 30 through a main shaft. The lower mold main ram servo unit 10 operates the lower mold 20 through a main shaft. In such a case, the upper mold 30 and the lower mold 20 move in one direction, for example, in a vertical direction.

A rotating mechanism may be provided under the lower mold 20. In this case, the rotating mechanism may rotate the lower mold 20 on a horizontal plane. Note that the horizontal plane is not limited to an exactly horizontal plane, and instead includes a plane inclined to a certain degree in light of the technical purpose.

As shown in FIG. 1, the lower mold main ram servo unit 10 may be provided at a lower part of the motor-driven powder molding machine 1. The lower mold main ram servo unit 10 may include a servomotor. In such a case, the servomotor moves the lower mold 20. The servomotor is used for moving the lower mold 20 and the compression forming of the powder material.

As shown in FIG. 1, the upper mold 30 is disposed above the lower mold 20. The upper mold 30 and the lower mold 20 are molds for compression forming the powder material filled in the cavity.

The upper mold main ram servo unit 40 is provided above the upper mold 30. The upper mold main ram servo unit 40 may include a servomotor. A plurality of the servomotors may be provided. The upper mold main ram servo unit 40 moves the upper mold 30.

The control unit 50 controls moving speeds of the upper mold 30 and the lower mold 20 of the motor-driven powder molding machine 1. The control unit 50 moves the lower mold 20 and the upper mold 30 by controlling the servomotor.

The lower mold auxiliary ram servo unit 70 is provided under the lower mold 20. The lower mold auxiliary ram servo unit 70 may include an auxiliary ram drive slide. In such a case, a linear motion ball screw may be disposed on the auxiliary ram drive slide. The lower mold auxiliary ram servo unit 70 controls the operation speed of the lower mold 20 by operating in synchronization with the lower mold main ram servo unit 10. The lower mold auxiliary ram servo unit 70 applies a pressure to the filled powder material by operating the lower mold 20 through an auxiliary shaft to perform compression forming.

The upper mold auxiliary ram servo unit 80 is provided above the upper mold 30. The upper mold auxiliary ram servo unit 80 may include an auxiliary drive slide. In such a case, a linear motion ball screw may be disposed on the auxiliary ram drive slide. The upper mold auxiliary ram servo unit 80 controls the operation speed of the upper mold 30 by operating in synchronization with the upper mold main ram servo unit 40. The upper mold auxiliary ram servo unit 80 applies a pressure to the filled powder material by operating the upper mold 30 through an auxiliary shaft to perform compression forming.

A main shaft load cell 14a is provided on the main shaft, and auxiliary shaft load cells 14b and 14c are provided on the auxiliary shaft. The load cells 14a, 14b, and 14c are used as pressure detector for detecting the pressures applied in an axial direction. Thus, pressure detector such as a pressure gauge may be used instead of the load cells 14a, 14b, and 14c. The load cell may be provided on either the main shaft or the auxiliary shaft.

In this case, the control unit 50 monitors the pressures applied in the respective axial directions using the load cells 14a, 14b, and 14c. Based on the pressures detected by the load cells 14a, 14b, and 14c, the control unit 50 may control the operation speed of at least one of the lower mold main ram servo unit 10 and the lower mold auxiliary ram servo unit 70, or may control the operation speeds of both the lower mold main ram servo unit 10 and the lower mold auxiliary ram servo unit 70 so that these pressures fall within a predetermined range. Based on the pressures detected by the load cells 14a, 14b, and 14c, the control unit 50 may control the operation speed of at least one of the upper mold main ram servo unit 40 and the upper mold auxiliary ram servo unit 80 or may control the operation speeds of both the upper mold main ram servo unit 40 and the upper mold auxiliary ram servo unit 80 so that these pressures fall within a predetermined range.

In addition, in order to prevent damage to equipment when a rapid increase in the pressurizing speed occurs in the load cells 14a, 14b, and 14c, a main shaft pressure absorbing member 15a the auxiliary shaft pressure absorbing members 15b and 15c are provided between the ball screws of the main shaft and the auxiliary shaft of each of the upper and lower molds and the load cells 14a, 14b, and 14c, respectively. The main shaft pressure absorbing member 15a and the auxiliary shaft pressure absorbing members 15b and 15c are mechanical shock absorbing members, and may be composed of, for example, a simple hydraulic cylinder. The main shaft pressure absorbing member 15a and the auxiliary shaft pressure absorbing members 15b and 15c may be operated when the pressure applied to at least one of the main shaft 11 and the auxiliary shafts 12 and 13 in the axial direction becomes a predetermined value or higher. In such a case, a sensor for detecting the operation of each pressure absorbing member may be provided, and the control unit 50 may detect the operation of the main shaft pressure absorbing member 15a and the auxiliary shaft pressure absorbing members 15b and 15c.

Here, the predetermined value is a value higher than an upper limit value of the predetermined range of the pressure applied in the axial direction when the control unit 50 controls the operation speed of the mold. The predetermined value is lower than the pressure applied in the axial direction when one of the upper mold 30 and the lower mold 20, which moves in a direction in which an elastically retreating pressure is applied, reaches a limit position of the movable range due to a movement of the other one of the upper mold 30 and the lower mold 20.

Furthermore, a configuration in which the positions of the upper 30 and the lower mold 20 are monitored using a linear sensor may be employed. In such a case, the control unit 50 may obtain actual speeds of the upper mold 30 and the lower mold 20 using the linear sensor. Here, the actual speed indicates a real speed, and refers to, for example, a real speed of the upper mold calculated based on the movement of the position of the upper mold. By operating the auxiliary shafts 12 and 13 in synchronization with the main shaft 11, thorough forming is possible, and a complicated sintered part can be formed with high accuracy.

As an operation of the motor-driven powder molding machine 1, a method of forming a powder material and a method of controlling the motor-driven powder molding machine 1 in powder molding will be described. As a method for forming the powder material filled in the cavity, for example, proportional forming is used. The proportional forming is a forming method in which compression is performed by delaying the lower mold 20 at a constant rate with respect to the upper mold 30.

According to the motor-driven powder molding machine 1 of this embodiment, it is possible to reduce a rapid increase in the pressurizing speed, which causes damage to the equipment. Further, by providing the main shaft pressure absorbing member 15a and the auxiliary shaft pressure absorbing members 15b and 15c, it is possible to prevent damage to the equipment as a fail-safe function.

### Second Embodiment

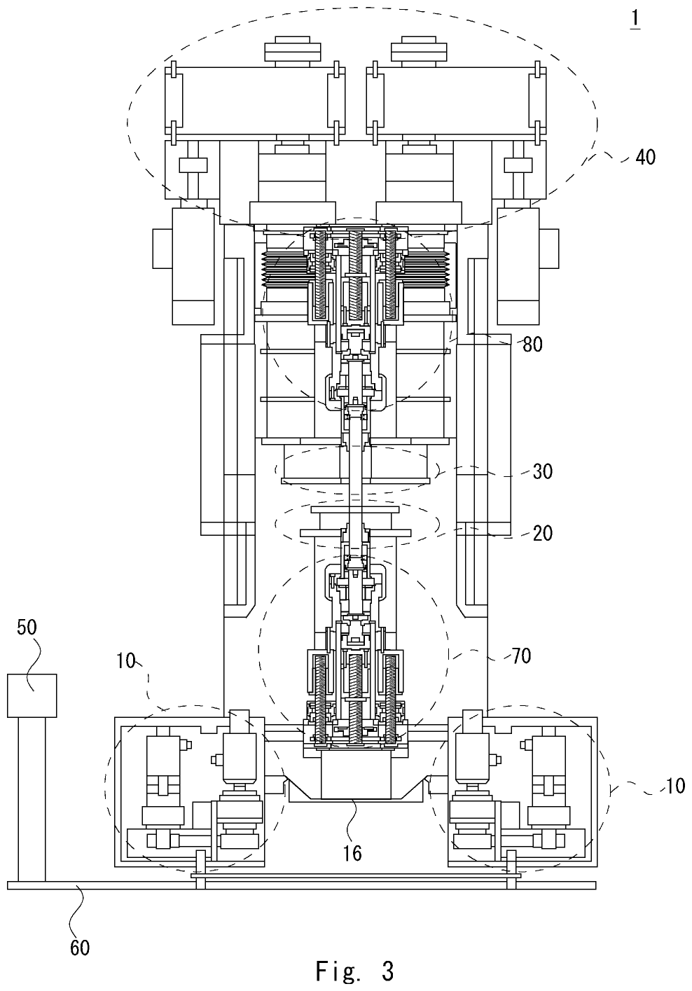

A motor-driven powder molding machine 1 according to this embodiment will be described with reference to FIG. 3. FIG. 3 is a cross-sectional view showing a configuration of the motor-driven powder molding machine 1 according to this embodiment. Unlike the first embodiment, the motor-driven powder molding machine 1 according to this embodiment includes two lower mold main ram servo units 10.

As shown in FIG. 3, the lower mold main ram servo units 10 may be provided at a lower part of the motor-driven powder molding machine 1. Each of the lower mold main ram servo units 10 may include a servomotor. The two lower mold main ram servo units 10 are arranged under the lower mold 20 and are arranged with a space therebetween in the horizontal direction. Note that the number of the lower mold main ram servo units 10 is not limited to two, and instead may be three or more.

As shown in FIG. 3, the two lower mold main ram servo units 10 are connected and linked to both ends of a lower mold main ram servo unit coupling bar 16 extending in the horizontal direction. In this way, the coupling bar 16 serves as a link mechanism for the two lower mold main ram servo units 10. Therefore, the two lower mold main ram servo units 10 operate synchronously. The link mechanism may move vertically between the two servomotors.

As in the motor-driven powder molding machine according to this embodiment, by arranging the two lower mold main ram servo units 10 with the coupling bar 16 interposed therebetween, the forces required for moving the lower mold 20 and compressing the powder material can be shared between the two lower mold main ram servo units 10, and the lower mold main ram servo unit 10 can be miniaturized.

In addition, when a rapid increase in a pressure occurs due to one of the lower mold 20 and the upper mold 30 reaching the limit position of the movable range, the coupling bar 16 is elastically deformed to serve as a cushion for a formed product. By including the link mechanism using the coupling bar 16, it is possible to reduce the possibility of the equipment being damaged.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A motor-driven powder molding machine for molding powder using an upper mold and a lower mold, the motor-driven powder molding machine comprising:
in each of the upper and lower molds,
a main ram configured to operate the upper or lower mold through a main shaft;
an auxiliary ram configured to operate the upper or lower mold through an auxiliary shaft in synchronization with the main ram;
a pressure detector for detecting a pressure in an axial direction in at least one of the main ram and the auxiliary ram; and
a controller for controlling operation speeds of the upper and lower molds by at least one of the main ram and the auxiliary ram so that the pressure falls within a predetermined range based on the detected pressure.

2. The motor-driven powder molding machine according to claim 1, further comprising:
a pressure absorbing member configured to absorb the pressure in at least one of the main shaft and the auxiliary shaft, the pressure absorbing member being operated when the pressure applied in the axial direction becomes a predetermined value or higher.

3. The motor-driven powder molding machine according to claim 2, wherein
the predetermined value is a value higher than an upper limit value of the predetermined range.

4. The motor-driven powder molding machine according to claim 2, wherein
the predetermined value is lower than a pressure applied in the axial direction when one of the upper and lower molds moving in a direction in which the elastically retreating pressure is applied reaches a limit position of a movable range due to a movement of the other one of the upper and lower molds.

5. The motor-driven powder molding machine according to claim 2, wherein
the pressure absorbing member is composed of a hydraulic cylinder.

6. The motor-driven powder molding machine according to claim 1, wherein
the pressure detector is provided for each of the main ram and the auxiliary ram.

7. The motor-driven powder molding machine according to claim 6, wherein
the pressure detector is provided for all of the main ram and the auxiliary ram provided for each of the upper and lower molds.

8. The motor-driven powder molding machine according to claim 7, wherein
the controller is configured to control the operation speed so that the pressures detected by all the pressure detectors fall within the predetermined range.
